(19) United States
(12) Patent Application Publication
(10) Pub. No.: US 2005/0044035 A1
(43) Pub. Date: Feb. 24, 2005

(54) System and method for managing a stable of managed accounts over a distributed network

(76) Inventor: Stephen Scott, Atlanta, GA (US)

Correspondence Address: TROUTMAN SANDERS LLP, BANK OF AMERICA PLAZA, SUITE 5200, 600 PEACHTREE STREET , NE, ATLANTA, GA, 30308-2216, US

(21) Appl. No.: 10/892,385

(22) Filed: Jul. 15, 2004

Related U.S. Application Data
(60) Provisional application No. 60/487,782, filed on Jul. 15, 2003.

(51) Int. Cl. G06F 17/60

(52) U.S. Cl. 705/37

(57) ABSTRACT

Method and system that allows External Investors to participate in an Investment Fund consisting of a portfolio of Managed Accounts, such as hedge funds, with the security and liquidity provided by guaranteed securities. The guaranteed securities are provided to external investors in exchange for cash. An Investment Manager then selects a number of Trading Advisors from a list of emerging hedge fund managers to manage the individual hedge funds and distributes the assets among the hedge funds according to set of allocation rules. The Investment Manager dynamically monitors the trading activities of each Trading Advisor through a computer system over a disturbed network. Investment Manager also determines a lock-in dividend rate for the issued securities based on the daily activity of each of the hedge funds, which is paid to the External Investors at the end of the year.

### CROSS-REFERENCE TO RELATED APPLICATIONS

This application claims priority under 35 U.S.C. §119 to U.S. Provisional Patent Application Ser. No. 60/487,782, entitled “SYSTEM AND METHOD FOR MANAGING A STABLE OF MANAGED ACCOUNTS OVER A DISTRIBUTED NETWORK,” filed on Jul. 15, 2003.

### TECHNICAL DESCRIPTION OF THE INVENTION

The present invention is directed to a method of managing a fund of hedge funds over a distributed network and more particularly to a method of managing the performance of individual managers controlling the individual hedge funds over a distributed network.

### BACKGROUND OF THE INVENTION

In times when Wall Street is captured by a “Bear” market, investors begin pulling their money out of conventional investment tools, such as stocks, equity funds, bond funds, and money market funds and look toward alternative investment tools in hopes of attaining a positive return on their investment. One such alternative investment tool is a hedge fund. A hedge fund uses a pool of capital for leveraging an investment portfolio that uses a private partnership as its structural format. The private partnership consists of a General Partner, who is typically the investment manager of the fund, and Limited Partners, who are the individual investors. The General Partner receives a fee for managing the investments, but only if the fund is productive. Therefore, by heavily weighting the investment manager's fee based on performance incentives, hedge funds typically attract the brightest individuals in the investment business and thus are attractive to investors.

Historically, the primary goal of hedge funds has been to reduce volatility and risks while preserving capital and providing positive returns under all market conditions. Typically, hedge funds utilize a variety of financial strategies to minimize the risks to investors, enhance returns, and minimize the correlation between the equity and bond markets. For example, hedge funds may employ short selling or arbitrage, engage in trading derivatives, investing in the anticipation of specific events, such as mergers or acquisitions, and investing in deeply discounted securities. This versatility allows hedge funds to generate positive returns on investment regardless of whether equity and bond markets are rising or falling.

Hedge funds provide several advantages over standard mutual fund investments. First, as mentioned above, hedge funds are established to deliver absolute returns. That is, the primary goal of hedge funds is to return a profit under all circumstances—even in a Bear market. The success of mutual funds, on the other hand, is compared to a relative index, such as the Dow Jones Industrial Averages, Standard and Poors 500, or other index. Thus, a mutual fund may have a negative return but still be considered successful if it outperforms the indices.

Another advantage is that hedge funds are particularly suited to protect investors against declining markets. Because hedge fund managers have a wide variety of hedging strategies available to them, hedge fund managers are able to generate absolute positive returns in declining markets. Mutual funds, on the other hand, are limited to converting a portion of their portfolios to cash or to shorting a limited portion of stock index futures to protect portfolios against declining markets.

Yet another advantage of hedge funds over mutual funds is that hedge funds are unregulated and, therefore, unrestricted in their investment options. Thus, managers of hedge funds are free to employ a variety of strategies to increase profits or reduce volatility. Mutual funds, on the other hand, are highly regulated and are restricted to the use of non-conventional investments, such as short selling and trading in derivatives, which make it more difficult for fund managers to outperform the market. However, conventional hedge funds have one restriction, which is imposed by professional investors. Professional investors expect and typically require that the hedge fund manager limit his or her investments within an area of specialization and competence. Thus, hedge funds tend to operate within a given specialization, which requires a particular expertise by the manager.

Although hedge funds provide a powerful alternative to and provide advantages over conventional mutual funds for investors, hedge funds have several drawbacks. First, unlike mutual funds, hedge funds are not available to the general public. Rather, hedge funds are available only to Accredited Investors and Qualified Purchasers. Accredited Investors are individuals whose net worth exceeds one million dollars, or individuals whose individual income exceeded two hundred thousand dollars, or whose joint income with a spouse exceeded three hundred thousand dollars in each of the two preceding years. Qualified Purchasers, also known as “super” Accredited Investors, are individuals, whose investments total more than five million dollars, either individually or jointly, family businesses that have more than five million dollars in investments, business that have discretion over twenty-five million dollars in investments, and trust sponsored Qualified Investors. Furthermore, only one hundred Accredited Investors, or an unlimited number of Qualified Purchasers, may invest in any single hedge fund. However, typical hedge funds have fewer than one hundred investors. Therefore, the pool of potential investors for hedge funds is limited.

Another limitation of hedge funds is that they are not diversified. Hedge funds are typically limited to a single sector, niche, or industry. Although hedge funds are designed to provide an absolute return, the non-diversification can lead to high risks and high volatility. For example, if particular hedge fund investments are limited to the technical sector (e.g., computing stocks, telecommunications stocks, etc.) the return on investments may vary widely with changes in the technical sector of the stock market. Although hedge funds are designed to minimize the volatility and risks, investing in a single sector can lead to wildly inherent fluctuations in the rate of return, which may be more than some investors are willing to tolerate. Furthermore, investment strategies differ between different managers. Each hedge fund manager will apply different amounts of hedging and different amounts of leverage to his or her portfolio, thereby leading to different amounts of risk. The different management styles in coordination with the single sector investing of hedge funds may increase the volatility beyond the point many potential investors are willing to accept.

One method to minimize the volatility of investing in a single hedge fund was the creation of a “fund” of hedge funds, or a “fund of funds” as it is commonly known. A fund of funds mixes and matches the most successful hedge funds and pooled investment vehicles into a single fund, thereby spreading the investments among several different types of hedge funds and investment vehicles. A fund of funds mixes a variety of hedge funds and management styles to meet an investor's specific goals and risk/reward objectives while diversifying his or her portfolio. By diversifying the fund's classes and the management strategies of the fund managers, a more consistent return may be achieved. Also, the volatility of the funds can be controlled depending on the mix and ratio of investment strategies integrated into the fund. Thus, by creating a fund of funds, the goals and risk/reward objectives can be tailored to the needs of individual investors. However, the fund of funds approach has several drawbacks. First, conventional fund of funds still require that any investor must meet the requirements for an individual hedge fund. For example, fund of funds are only available to Accredited Investors and Qualified Purchasers. Furthermore, the minimum investment amounts associated with individual hedge funds also applies to the fund of funds. Moreover, the fund of funds is still a Limited Liability Partnership. Therefore, the individual investors, or limited partners, retain a substantial amount of risk.

Therefore, there is a continuing need for a method for allowing investors to participate in a portfolio of hedge funds managed by an emerging manager, with the security and liquidity provided by a guaranteed United States dollar or foreign-backed securities.

### SUMMARY OF THE INVENTION

The present invention meets the needs described above in an Investment Fund that provides investors with access to a diverse team of emerging managers while providing a unique management structure that provides both transparency and capacity not found in conventional hedge funds. Generally described, the invention includes an Investment Fund, which is backed by United States dollar or foreign-backed securities in the form of notes, for dynamically monitoring a number of hedge fund managers over a distributed network. An Investment Manager, which is typically a limited liability company, issues notes to External Investors in exchange for their external investment of cash. The Investment Manager then selects a number of Trading Advisors to manage a variety of hedge funds in individual managed accounts. Once the Trading Advisors have been selected, the Investment Manager allocates the investment received from the external investors among the hedge funds according to a set of pre-defined allocation rules. The Investment Manager then dynamically monitors the trading activities of each Trading Advisor through a computerized system over a distributed network.

In addition to monitoring the individual Trading Advisors, the Investment Manager also determines a lock-in dividend rate for the issued United States dollar or foreign-backed securities based on the change in the net asset value of each of the managed accounts from one year to another year.

More particularly described, the invention provides a mechanism in which the External Investors' investments are backed by United States dollar or foreign-backed securities in the form of notes. By purchasing guaranteed notes, the risk to the individual investor associated with hedge funds is borne by the Investment Advisor, which issues the guaranteed notes, thereby providing a level of security not found in typical hedge funds.

Another aspect of the invention is that the Investment Advisor selects the Trading Advisors from a pool of emerging managers. “Emerging managers” is defined as managers who are at a particular stage in their career when the business of a hedge fund becomes viable. However, a manager loses “emerging manager” status when the success of the hedge fund limits the manager's performance due to excess assets under management, or when the personal success of the manager lessens his or her desire and commitment to manage the hedge fund.

Another aspect of the invention is that the assets of each hedge fund are held by a Prime Broker. At the end of each Calculation Date, or business day, the Prime Broker calculates the daily net asset value (NAV) for each hedge fund and forwards them to the Investment Manager over the distributed network. The Investment Manager then compares the daily NAVs for each hedge fund against a set of predetermined values. If any of the hedge funds falls below the predetermined values, the Investment Manager may take corrective action, which may range from limiting the Trading Advisor to trading at the Prime Broker to dismissing the relevant Trading Advisor and liquidating the assets in the particular hedge fund.

Yet another aspect of the invention is that the Investment Manager determines the number of hedge funds open in the Investment Fund at any given time and how the invested capital will be allocated among the open hedge funds in accordance with a set of allocation guidelines. After the Investment Manager initially allocates the invested capital to the individual hedge funds, the Investment Manager monitors the allocation levels of the invested capital and continually adjusts the allocation levels to ensure the invested capital is distributed in accordance with the allocation guidelines.

Yet another aspect of the present invention is to allocate a fixed percentage of the invested capital into a segregated account, which is controlled by the Investment Manager and used to minimize excessive exposure and manage the risk to the overall Investment Fund. A small percentage, typically about five (5%) of the invested capital, is invested in a segregated account, which is held by the Bank. The segregated account is available to the Investment Manager to “hedge” against any exposure he or she feels is extreme. For instance, if the Investment Manger believes that a large number of Trading Advisors have taken the same position for the same investment, then the Trading Manager may take the opposite position using the funds from the segregated account to minimize the exposure of the Investment Fund.

It is yet another aspect of the present invention to allow the External Investors to have total transparency and access to each of the fund's trading histories, daily NAV, and information regarding each Trading Advisor through a distributed network, such as the Internet. The External Investors, may access the information through a protected Web site through the Investment Manager.

The various aspects of the present invention may be more clearly understood and appreciated from a review of the following detailed description of the disclosed embodiments and by reference to the appended drawings and claims.

### BRIEF DESCRIPTION OF THE FIGURES

FIG. 1 is block diagram illustrating an Investment Fund in accordance with the invention.

FIG. 2 is a block diagram illustrating a transaction cycle in accordance with the present invention.

FIG. 3 is a logic flow diagram illustrating a routine for the transaction cycle in accordance with the present invention.

FIG. 4 is a logic flow diagram illustrating a routine for allocating subscriptions among the Managed Accounts by the Investment Manager in accordance with the present invention.

FIG. 5 is a logic flow diagram illustrating a routine monitoring the daily activity of the Trading Advisors.

### DETAILED DESCRIPTION OF THE EMBODIMENTS

The present invention is typically embodied in an Investment Fund, which allows an Investment Manager to monitor the ongoing activities of a number of Trading Advisors on a real-time basis over a distributed network. The Investment Fund is administered by a trading company (hereinafter “Company”), which allows investors access to a diverse portfolio of hedge funds. The Company is typically a limited liability corporation and may be incorporated outside the United States, or “offshore.” For example, the Company may be incorporated in the Bahamas, the Cayman Islands, Bermuda, or the like. The Company will manage the hedge funds and oversee the trading of assets within the managed accounts. To accomplish this task, the Company is composed of an Administrator and an Investment Manager.

The Administrator is selected by the Company and may be a company or an individual. The Administrator is the administrative agent of the Company and generally is responsible for conducting the day-to-day business. More specifically, the Administrator is responsible for providing the valuation of both the assets and obligations for the Company. The Administrator must also communicate with and answer any question posed by External Investors in connection with the issuance of the notes. This includes, but is not limited to, preparing and maintaining all customary financial and accounting records in the appropriate form and with sufficient detail to support the preparation of an annual independent audit, which assesses the financial well-being of the Company.

The Administrator also, subject to the supervision of the Investment Manager, calculates the Net Asset Value (NAV) per note on a monthly basis and makes the calculations available to the Company. The Administrator also prepares a monthly trading report that includes the NAV note and provides the monthly trading report to the External Investors and the Company. The Administrator also prepares any other relevant reports, including but not limited to the business and financial condition of the Company, the portfolio of investments in each Managed Account, and the trial balance and reconciliations for the custody and cash accounts.

The Investment Manager is responsible for implementing a diversified investment strategy and arranging for the performance of all accounting and administrative services for the Company. The primary duty of the Investment Manager is selecting and managing the individual Trading Advisors that will oversee each of the Managed Accounts. Typically, the individual Trading Advisors are selected from a list of candidate “emerging” hedge fund managers. “Emerging” managers are defined as those managers who are entering into a period in their trading careers when the business of the general partner becomes viable. That is, when the funds these managers are managing are returning a profit such that the funds become attractive to new investors. Once the list of emerging hedge fund managers are identified, the Investment Manager evaluates each candidate based on a set of predefined criteria, which may include the emerging manager's past strategy, performance, structure, principles, commitment, and the like.

In evaluating the strategy of each potential emerging manager, each emerging manager must be able to coherently describe a definable investment discipline to the Investment Manager. Additionally, the candidate's trading history must exhibit their defined investment discipline. The Investment Manager also may scrutinize the candidate's trading methodology in terms of the candidate's past portfolio turnover, risk/reward structure, and the viability of their approach to money management.

The Investment Manager may also evaluate each candidate's past performance by reviewing the audited returns for the candidate's past portfolios. This provides the Investment Manager with an estimate of the portfolio's consistency, volatility, and compound return on investment. In evaluating the structure of a candidate's portfolio, the Investment Manager is looking at the strategic makeup and size of the portfolio to determine whether the candidate has overextended his or her trading position or that the candidate has concentrated a majority of the portfolio's assets to any single investment so as to create an unreasonable risk. Additionally, the Investment Manager may look at the legal and accounting framework of the candidate's portfolio, as well as potential conflicts of interest to insure that the candidate is diligent in maintaining ethical and legal standards. Furthermore, the Investment Manager may examine the relationships that the candidate has established with prime brokerage houses and other investment firms to determine whether the candidate can establish and maintain the requisite business relationships required to properly manage a hedge fund.

Another criterion the Investment Manager may use to evaluate a potential candidate is the candidate's investment principles. Assessing the stability and consistency of the candidate is an important step within the due diligence process. The Investment Manager gives special consideration to the candidate's employment and educational background, his or her personal and professional ethics, employment history, and personality traits, as they define the candidate's character.

Yet another criterion that the Investment Manager may use to evaluate a candidate is the level of the financial commitment he or she is willing to undertake. The Administrator requires that each Trading Advisor invest a significant portion of his or her net worth in the hedge fund that he or she manages.

Although the present invention describes using the candidate's strategy, performance, portfolio structure, principles, and commitment as the five criteria to select the Trading Advisor for each hedge fund, those skilled in the art will appreciate that the Investment Manager may use any combination of the criteria or any other criteria that the Investment Manager believes is relevant in selecting the Trading Advisors from a list of “emerging” hedge fund managers.

The Investment Manager is also responsible for determining the allocation of assets among the Managed Accounts. For each Calculation Date, the Trading Exposure of the Investment Fund, which is defined as the aggregate amount of all allocations, is determined as the sum of the net asset value (NAV) of each managed account. The Investment Manager also determines the number of Managed Accounts that are active at any given time. The allocations of assets among the Managed Accounts are subject to several limitations. First, no single Managed Account may hold more than a predetermined percentage of the Trading Exposure. The Bank, that is backing the investments, typically determines the predetermined percentage. In the present invention, the predetermined percentage is set at approximately twenty percent (20%). Thus, no single Managed Account may hold more than approximately 20% of the Trading Exposure of the Investment Fund. Second, a predefined number of Managed Accounts must have a non-zero balance at any given time.

Lastly, within the trading style designation given to each of the Managed Accounts, the overall concentration limits for the hedge fund styles must be observed across all the Managed Accounts according to Table 1.

TABLE 1
Concentration Limits for Hedge Fund Styles Used
in the Managed Accounts.

| | Approximate |
|---|---|
| Hedge Fund Style | Concentration Limit |
| Convertible Arbitrage | 40% |
| CTA/Futures | 0% |
| Distressed Securities | 15% |
| Equity Dedicated Short Selling | 25% |
| Equity Long/Short | 60% |
| Event Driven/Merger Arbitrage | 40% |
| Fixed Income Arbitrage | 20% |
| Fund of Funds | 0% |
| Index Arbitrage | 20% |
| Marketing Timing/Directional | 40% |
| Multi-Strategy | 40% |
| Short-Term Trading | 30% |
| Statistical Arbitrage | 40% |

When any allocation to a Trading Advisor is outside any of the trading limitations, the Investment Manager may reallocate the assets of the Trading Exposure, with approval from the Bank, among the current Trading Advisors, such that the allocations meet all of the trading limitations. Alternatively, the Investment Manager may add additional Trading Advisors as needed to meet the trading limitations.

Once the Trading Advisors have been selected and the allocations completed, the Investment Manager may monitor the activities of each of the Trading Managers on a daily basis. The Investment Manager is connected to each of the Trading Advisors' accounts at the Bank through a distributed network, such as a local area network (LAN) or a wide area network (WAN). The Investment manager may also be connected to each of the Trading Advisors' accounts through the Internet through an encrypted website. The Investment Manager, through the distributed network, may monitor the trading activities of the Trading Advisors on a real-time basis. If the Investment Manager detects trading activities by a Trading Advisor that are inconsistent with the trading limitations, the Investment Manager may have the authority to halt the trading activities of the offending Trading Advisor. Although the Investment Manager has access to monitor the trading activities of each Trading Advisor, the Investment Manager does not have access to the Managed Accounts. Nor is the Investment Manger able to pledge assets to the Managed Accounts.

In monitoring the Managed Accounts, each Managed Account is subject to risk management by the Company. The Company, on a daily basis, monitors the Trading Exposure of the Fund, which is subject to the following Constraint on Trading Exposure:
Trading Exposure≦Leverage Factor×F

Where F is defined as the face value of the outstanding U.S. dollar-backed securities 108 on the relevant Calculation Date and the Leverage Factor is given by the equation:

$$Leverage Factor = Max ( Min ( 5 * \frac{NAV - ( Zero + 0.04 * N )}{N} , 1.5 ) , 0 )$$

where NAV is the net asset value of the fund, N is the number of outstanding U.S. dollar-backed securities 108, and Zero is the amount of money needed to buy United States of America Treasury zero coupon bonds or any other such investment instrument maturing on, or shortly before, the Maturity Date of the outstanding U.S. dollar-backed securities 108 with the maturity amount equal to the U.S. dollar-backed securities 108.

At the end of each Calculation Date, if the Trading Exposure of the individual managed account does not meet the trading constraint, the Investment Manager notifies the appropriate Trading Advisor that the Managed Account is in breach of the Constraint on the Trading Exposure. The Trading Advisor may be given several business days to cure the breach. Typically, the Trading Advisor may have two business days to cure the breach. If the Trading Advisor fails to cure the breach within the prescribed time, a Stop Trading Trigger is set on the managed account and the Trading Advisor is blocked from conducting additional trades. Once the Stop Trading Trigger is set, the Investment Manager must within several day of the occurrence of the Stop Trading Trigger, either liquidate the assets of the managed account and transfer all proceeds to the Bank or ensure that any other funds or assets available to the managed account are transferred to the Bank. Additionally, the Investment Manager must provide a written notice to the Bank indicating that he or she has instructed the relevant Trading Advisor to halt trading and close out all positions after the occurrence of the Stop Trading Trigger.

Another constraint placed on the Managed Accounts is the Constraint on Daily Volatility on Net Asset Value per note. The daily volatility indicator of the managed fund, defined as σ_{D}, is compared to a predefined value, as set by the Bank. The Daily Volatility Indicator is given by the following equation:

$${σ}_{D}^{N} = \sqrt{\frac{1}{( N - 1 )} {\sum }_{i = 2}^{N} {( {B}_{i} - m )}^{2}} where m = \frac{1}{N} {\sum }_{i = 1}^{N} {B}_{i} and$$

$${B}_{i} = {ln}_{e} ( \frac{{NAV}_{i}}{{NAV}_{i - 1}} ) ,$$

where σ_{D}^{N} is the Daily Volatility indicator using the N most recent values and is determined by the equation:

$$σ = Max ( {σ}_{D}^{20} , {σ}_{D}^{250} )$$

where NAVᵢ is the ith estimate (or the actual value, when available) of the Net Asset Value per U.S. dollar-backed securities 108.

The Investment Manager monitors the daily volatility indicator, σ_{D}, for each Managed Account. If the Daily Volatility indicator falls below the predefined value, a Stop Trading Trigger Event may occur and the Investment Manager may notify the appropriate Trading Advisor that he or she is in breach of the Daily Volatility constraint. The Trading Advisor must cure the breach within a predefined time, typically two business days, or face having his or her trading privileges halted. If the Trading Advisor fails to cure the breach of the Daily Volatility constraint within the predefined time, the Stop Trading Trigger is set on the managed account and all trading is halted. The Investment Manager must then liquidate the assets of the managed account and transfer all proceeds to the Bank and ensure that any other funds or assets available to the managed account are transferred to the Bank, within a prescribed time of the occurrence of the Stop Trading Trigger. Additionally, the Investment Manager must also provide a written notice of the Stop Trading Trigger and liquidation of the accounts assets to the Bank.

Additionally, on each Calculation Date, the one loss for one period, L, of the managed account is calculated by the Investment Manager using the following formula:
L=Max(\sqrt{ΣΣwᵢwⱼσᵢσⱼρᵢⱼ},HistoricalMaximum L,σ_{D}×NAVoftheCompany)
where ρᵢⱼ for i=1 to i=M and for j=1 to j=M is the Correlation of Trading Advisor i with Trading Adviser j, M is the total number of Trading Advisors, wᵢ is the Trading Exposure allocated to Trading Advisor i, and wⱼ is the Trading Exposure allocated to Trading Advisor j. The Historical Maximum L is equal to the maximum percentage loss, calculated over the previous four calendar years.

In addition to the constraints, the Investment Advisor may also be responsible for determining the Trading Capital Excess. For any given Calculation Date, the Trading Capital Excess is the amount equal to the greater of zero and the result of the NAV of the company less the Maturity At-Risk Amount less the Value of a Security Fund on the Calculation Date, where the MARAₘ is the Maturity At-Risk Amount and is given by the formula:
MARAₘ=F+Additional Amount−MPAₘ
where F is the face value of the outstanding U.S. dollar-backed securities 108, m is the number of days, and MPAₘ is the value of Maturity Protected Amount on the Maturity date and is given by the formula:
MPAₘ=Max(Value of the Security Fund−Value of Fess, 0)

The Security Fund is a segregated account in the name of the Company and is used to hold all Eligible Collateral, which consists of (i) cash in United States dollar or foreign-backed securities deposited with the Bank and/or any instrument used by the Bank representing United States dollar or foreign-backed cash deposits maturing on, or before, the Maturity Date, and (ii) all interest, dividends, cash, instruments, securities, and any other property received in respect of or as proceeds of, or in substitution of or exchange for, any of the foregoing instruments.

The assets of the Investment Fund 100 may be monitored on a daily basis by the Investment Manager to ensure that the Trading Capital Excess exceeds the Decrease Allocation Level and the Stop Trading Level, where the Decrease Allocation Level is given by:
Decrease Allocation Level=L*2.33*\sqrt{7}
and
the Stop Trading Level is given by:

$$Stop Trading Level = Max ( \begin{matrix}L * 2 * \sqrt{7} , Face value of US \$ - \\ Class Notes outstanding * 5 \% * \\ Max ( Leverage Factor , 1 )\end{matrix} )$$

If on any given Calculation Date, the Decrease Allocation Level is more than the Trading Capital Excess, then the Investment Manager must increase the Trading Capital Excess to the Decrease Allocation Level by the Breach Adjustment Date. If the Investment Manager fails to increase the Trading Capital Excess to the Decrease Allocation Level, a Stop Trading Trigger Event is triggered and the assets are liquidated.

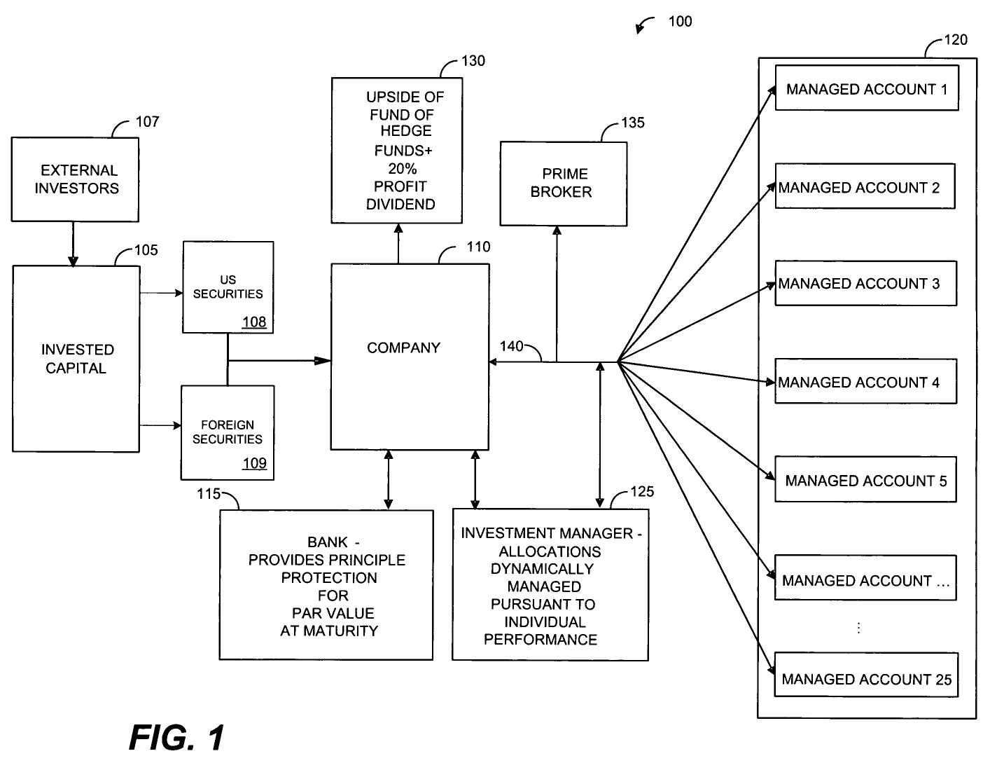

Turning now to the figures, in which like numerals refer to like elements through the several figures, FIG. 1 is a block diagram of an investment fund 100, in which Trading Advisors, may be dynamically managed over a distributed network to insure that the investment strategies of the fund are met. The investment fund 100 consists of Invested Capital 105 provided by External Investors 107. The External Investors 107 provide the Invested Capital 105 is to a Company 110, which is typically a limited liability holding company incorporated outside the United States, or “offshore,” to invest in a series of Managed Account 120 run by the Trading Advisors. In the present invention, the Managed Accounts 120 are hedge fund accounts, although those skilled in the art will appreciate that the Managed Accounts 120 may consist of other types of funds without departing from the scope of the invention. Upon receiving the Invested Capital 105, the Company 110 purchases either guaranteed U.S. dollar-backed securities 108 or foreign currency-backed securities 109 and issues subscriptions to the External Investor 107 consisting of currency denominated securities, known as notes. The notes may be bonds that have a guaranteed repayment of the principal on the Maturity Date of the bond, which are guaranteed by a Bank 115. In the present invention, the Maturity Date for the notes is eight (8) years from the issue date and is set by the Bank 115. It should be noted that the Bank 115 may set the Maturity Date to a length of time other than eight years from the issue date. Backing the Invested Capital 105 by notes is a unique feature of the present invention that is not shared by conventional hedge funds. Typically, hedge funds are limited liability partnerships, in which the Trading Advisor is the general partner and the External Investors 107 are limited partners. Therefore, in a conventional hedge fund, the External Investors 107 bear a substantial amount of risk, wherein their exposure is equal to their investment. In the present invention, the External Investors 107 purchase notes, whose principals, are guaranteed at maturity by the Bank 115, instead of investing in a limited liability partnership. The Company then invests the Invested Capital 105 in a number of different hedge funds. As a result, the External Investors 107 are allowed to expose their capital to the benefits provided by hedge funds without assuming the risks associated with conventional hedge funds. For the purposes of this application, only U.S. dollar-backed securities 108 will be used to discussed the guaranteed securities.

Another advantage of an Investment Fund is that by backing the Invested Capital 105 with guaranteed US dollar-backed-securities, the External Investors 107 may be entitled to an annual dividend. The U.S. dollar-backed securities 108 represent the obligation of the Company 110. The value of the U.S. dollar-backed securities 108 is based on the net asset value (NAV) of the Company's 110 investment plus the value of a Security Fund held and a Fee Payment Account minus any liabilities of the Company 110 attributed the U.S. dollar-backed securities 108. If at the end of the first financial year after issuing the U.S. dollar-backed securities 108, the NAV per U.S. dollar-backed securities 108 is greater than its face value, the Company 110 may provide the External Investors 107 holding the U.S. dollar-backed securities 108 with a dividend equal to a predetermined percentage of the difference between the face value and the NAV of the U.S. dollar-backed securities 108. For each subsequent year, the Company 110 may elect to pay a dividend to the External Investors 107 when the NAV per U.S. dollar-backed securities 108 exceed the Threshold Amount on the last valuation day in that particular year. The Company 110 sets the amount of the annual dividend paid to the External Investors 107 and lists them in the Investment Fund's prospectus. For the present invention, the dividend is set at twenty percent (20%) of the NAV above the face value of the U.S. dollar-backed securities 108 for a given year.

However, if a payment of a dividend in any given year was to either lead to a Decrease Allocation Event or a Stop Trading Trigger Event, then the Company may elect to pay a relevant portion of the dividend so as to avoid either the Decrease Allocation Event or the Stop Trading Trigger. This may mean that a smaller dividend payment is paid to the External Investors 107 or even that no dividend payment is made for that particular financial year.

Another advantage of the Investment Fund 100 is that any individual, regardless of their personal worth, may be an External Investor 107, unlike conventional hedge funds. Typically, conventional hedge funds are limited to “Accredited Investors” and “Qualified Purchasers.” The Investment Fund 100 imposes no such restrictions as to who may be an External Investor 107. Additionally, the number of External Investors 107 is not limited, as is the case with conventional hedge funds. Furthermore, minimum investment amount of each External Investor 107 for the Investment Fund 100 is much less than the initial investment for conventional hedge funds. It is common for conventional hedge funds to require limited partners to have a minimum investment between $250,000 and $500,000. And it is not uncommon for established conventional hedge funds to have minimum investments of up to $10,000,000. The Investment Fund 100 has an investment minimum far below that for conventional hedge funds. For the present Investment Fund 100, the minimum investment for an individual External Investor 107 is set at approximately $50,000. Thus, the Investment Fund 100 provides External Investors 107 access to hedging strategies, which they may not have previously had access to through conventional hedge funds.

Because the Company 110 is assuming most of the risk associated the Managed Accounts 120, the Company 110 incorporates a highly disciplined structure to manage the activity of the Trading Advisors on a daily basis. The Company 110 oversees the Managed Accounts 120 and is typically incorporated outside the United States, such as Bermuda, the Bahamas, the Cayman Islands, or the like. The specific objective of the Company 110 is to achieve substantial medium-term gains in the Investment Fund 100 through implementing a diversified investment strategy and closely monitoring and controlling the risk through daily monitoring of the individual Managed Accounts 120. To insure that the risk of the Investment Fund 100 is managed properly, the assets of each Managed Account 120 may be required to be held at the Prime Broker 135. At the end of each Calculation Date, which is defined as each business day in a period from and including the Issue Date of the U.S. dollar-backed securities 108 up to and including the Maturity Date, the Prime Broker 135 calculates the NAV for each Managed Account 120. The NAV is forwarded to the Investment Manager 125 over a distributed network 140. Since the Prime Broker 135 and the Investment Manager 125 are likely located in different geographic regions, the distributed network is typically a wide area network (WAN) or the Internet. The distributed network 140 may also be a local area network (LAN) if the Prime Broker 135 and the Investment Manager 125 are located in close geographic proximity to one another.

At the end of each Calculation Date, or business day, the NAVs received from the Prime Broker 135 are used to determine whether the NAV for each Managed Account 120 for that business day has increased of decreased from the previous business day. If the NAV for any Managed Account 120 has decreased from the previous business day, a determination is made whether the decrease is severe enough to warrant taking action against the relevant Trading Advisor, ranging from requiring that all trading by the relevant Trading Advisor be restricted to occurring at the Prime Broker 135 to removal of the relevant Trading Advisor and liquidating the assets of the Managed Account 120.

In addition, the Investment Manager 125 is directly connected over the distributed network 140 to each of the Managed Accounts 120. This allows the transactions of each of the Trading Advisors to be monitored in real time and insure that the transactions performed by the Trading Advisors are performed in accordance with trading constraints set out by the Bank 110. Additionally, the level of assets in each Managed Account 120 is monitored to insure that the appropriate allocation of the Invested Capital 105 is maintained in each Managed Account 120. If the allocation of the Invested Capital 105 in any particular Managed Account 120 does not meet the required allocation levels, then the appropriate actions may be taken to bring the allocation of Invested Capital 105 in line with the required allocation levels.

In addition to supplying the daily NAV, the Prime Broker 135 may also post the trading history, daily exposure, and daily NAV for each Managed Account 120 on a secure Web site, which is accessible only by the External Investors 107, providing the External Investors 107 with complete transparency to the Managed Accounts 120. Through the secure Web site, the External Investors 107 have the ability to access information about the individual Managed Accounts 120 and the Trading Advisors, which is not available in traditional hedge funds.

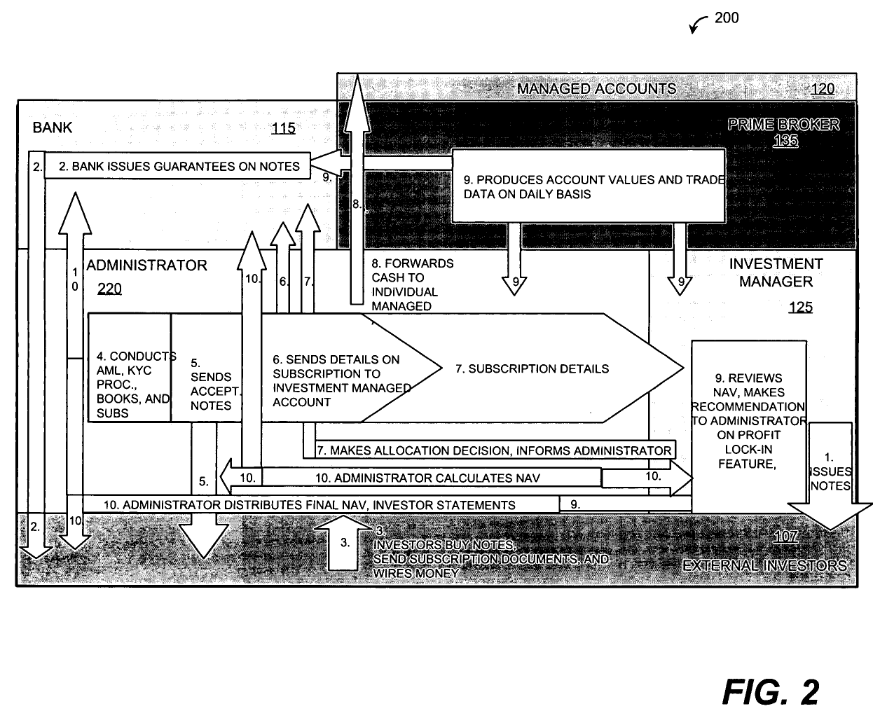

FIG. 2 is a block diagram illustrating a typical transaction cycle 200 for the present invention. The transaction cycle 200 begins when the Company 110 makes the notes available to the External Investors 107. It is through an Investment Manager 125 that the Company 110 makes available U.S. dollar-backed securities 108 to External Investors 107. The Bank 115 then issues guarantees on the U.S. dollar-backed securities 108. Next, the External Investors 107 purchase the U.S. dollar-backed securities 108 by sending cash either by wire, check, or any other standard method of payment to the Administrator 220. The Administrator 220 then conducts AML, KYC procedures and sends an acceptance of Notes to the External Investors 107.

Next, the Administrator 220 forwards the subscription details to the Investment Manager 125. Upon receiving the subscription details, the Investment Manager 125 reviews the subscriptions and makes suggestions as to how the assets should be allocated among the managed accounts. The Investment Manager 125 then sends the recommendations to the Administrator 220. The Administrator 220 approves or disapproves the allocation recommendations made by the Investment Manager 125. If the Administrator 220 approves of the allocation recommendations, then the Administrator 220 forwards the allocations to the individual Managed Accounts 120, where the Trading Advisors subsequently invest the cash in non-conventional investments.

At the end of each trading day, the Prime Broker 135 generates a number of reports related to the managed accounts. For example, the Prime Broker 135 calculates the NAV of each managed account and produces a daily log of the trade data for each Managed Account 120. The Prime Broker 135 then provides the reports to the Investment Manager 125, the Administrator 220, and the Bank 115. Additionally, the Prime Broker 135 ensures that the appropriate restrictions on the Managed Account 120 are followed. Specifically, the Prime Broker 135 ensures that all of assets of the individual Managed Accounts 120 are held at the Prime Broker 135. The Prime Broker 135 also ensures that all trades made by the Trading Advisors settle at the Prime Broker 135 on a daily basis. However, Prime Broker 135 may allow the Trading Advisors to trade at multiple firms, as long as all trades at the end of the day settle with the Prime Broker 135.

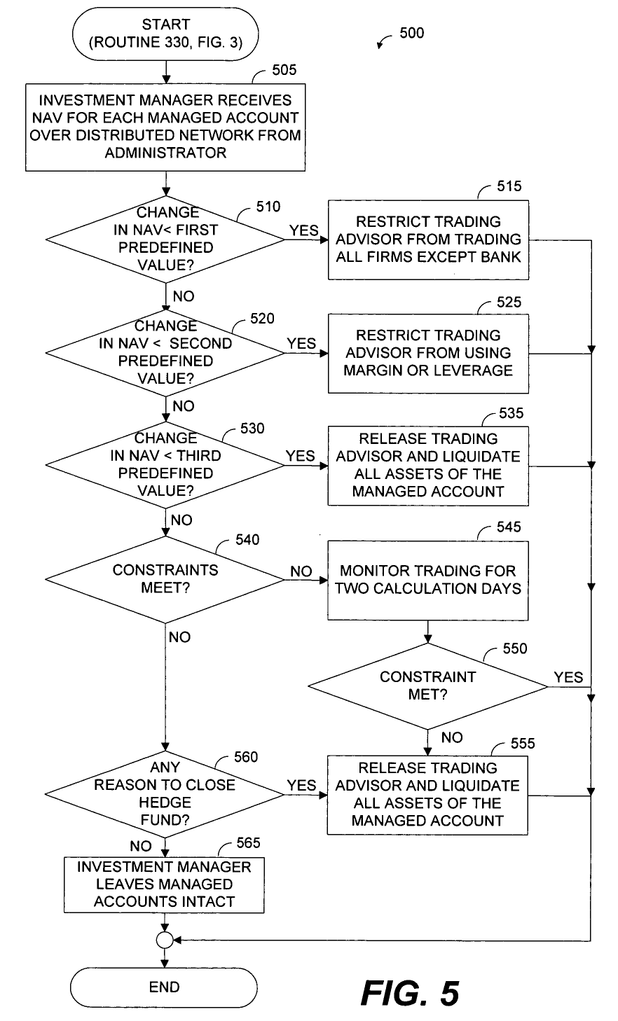

Next, the Investment Manager 125 examines the reports from the Prime Broker 135 to determine whether the Trading Advisors are properly managing their respective Managed Accounts 120. The Investment Manager 125 examines the NAV and trade data for each Managed Account 120 to determine whether the trading of the particular Managed Account 120 should be restricted or stopped altogether or whether to terminate the relevant Trading Advisor. This is discussed in further detail below in FIG. 5.

The Investment Manager 125 also makes recommendations to the Administrator 220 regarding a Profit Lock-In Feature. Subject to the trading performance of the Managed Accounts 120, the Investment Manager 125 may recommend that a portion of the net new trading profits attributed to the U.S. dollar-backed securities 108 may be used to purchase additional collateral, which is placed in the Security Fund. The Bank 115 then acts on the recommendation of the Investment Manager 125 regarding the purchase of additional collateral. If Investment Manger 125 recommends the purchase of additional collateral and the Bank 115 is in agreement, the Bank 115 certifies in writing the increase in the Guaranteed Amount for the U.S. dollar-backed securities 108. The External Investors 107 may relay on the certification by the Bank 115 as evidence of an increase in the Guaranteed Amount.

Finally, the Administrator 220 distributes the final NAV for each Managed Account 120 at the end of each month along with investors' statements and any certification by the Bank 115 for any and all increases in the Guaranteed Amount.

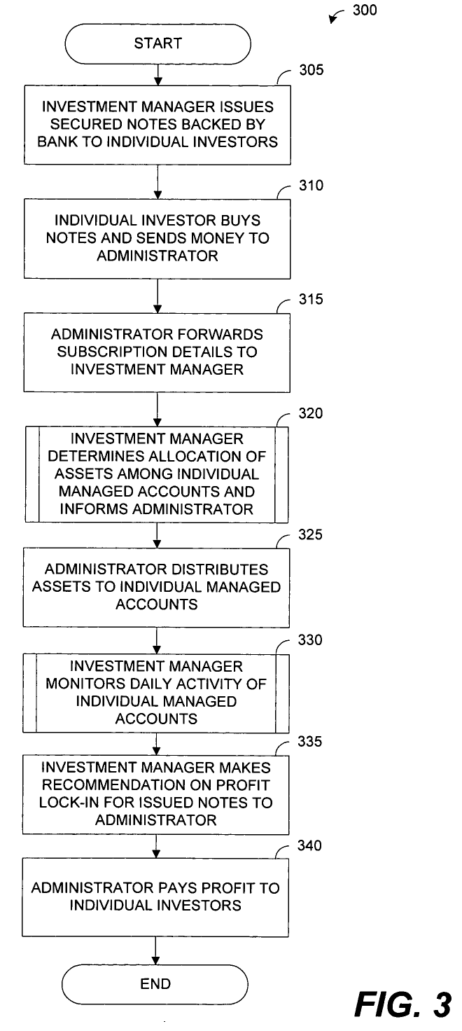

FIG. 3 is a logic flow diagram illustrating a routine 300 for completing a transaction cycle. The routine 300 begins at 305 when the Investment Manger 125 issues U.S. dollar-backed securities 108 secured by the Bank 115 for purchase by External Investors 107. At 310, the External Investors 107 purchase the U.S. dollar-backed securities 108 through the Administrator 220. At 315, the Administrator 220 forwards the subscription details regarding the U.S. dollar-backed securities 108 purchased by the External Investors 107 to the Investment Manager 125. Next, at 320 the Investment Manager 125 allocates the subscriptions among the individual Managed Accounts 120 according to a set of predetermined criteria. The Investment Manager 125 recommends to the Prime Broker 135 how the subscriptions should be allocated among the Managed Accounts 120. At 325 the Prime Broker 135, who holds all of the assets for the Managed Accounts 120, then distributes the assets between the Managed Accounts 120 according to the Investment Manager's 125 instructions.

At 330, the Investment Manager 125 monitors the activity of each individual Managed Account 120 on a daily basis. The Administrator 220 calculates the daily NAV and compiles the trading data for each Managed Account 120 at the end of each business day and forwards the data to the Investment Manager 125. The Investment Manager 125 compares the daily trading data and NAV for each of the Managed Accounts 120 against a set of predefined criteria to determine whether the Trading Advisors are managing their respective accounts properly to maintain an acceptable rate of return. If the Investment Manager 125 determines that any one of the Trading Advisors are not performing up to expectations, the Investment Manager 125 may recommend to the Administrator 220 that the Trading Advisor be reprimanded, which may vary from restricting the accounts that the Trading Advisor may make trades with to outright removal of the Trading Advisor.

The Investment Manager 125 also makes a recommendation to the Administrator 220 regarding any the Profit Lock-In for the issued U.S. dollar-backed securities 108 at 335. If the trading performance of the Managed Accounts 120 increases by a predetermined amount over a given period, the Investment Manager 125 may recommend that a portion of the net new trading profits should be used to purchase additional collateral, which is placed in a Security Fund. In the present invention, the Company 110 will purchase additional collateral each time the NAV of a given Managed Account increases by ten percent (10%) over a given period. It should be noted that only new trading profits for a given period may be used to purchase additional collateral. The Administrator 220 may not be allowed to use existing assets to purchase additional collateral. Upon purchasing additional collateral, the Bank 115 increases the Guaranteed Amount, and certifies the increase in writing, which the External Investors 107 may rely on as evidence of an increase in the Guaranteed Amount. The intent of the Profit Lock-In feature is to purchase enough additional collateral to provide a value on maturity approximately equal to fifty percent (50%) of any new net trading profits, after making good on any losses incurred during prior years.

Finally, at 340, the Administrator 220 pays any dividends to the External Investors 107, which they may be entitled to at the end of the fiscal year. External Investors 107 who are holding U.S. dollar-backed securities 108 are entitled to an annual dividend if the NAV per U.S. dollar-backed securities 108 at the end of the fiscal year is greater than the face value of the U.S. dollar-backed securities 108. The dividend would be a predefined percentage of the difference between the NAV and the face value of the US-Class Note. The predefined percentage for the dividend payment is determined by the Bank 115 and is set at approximately twenty percent (20%) for the present invention. It should be apparent to those skilled in the art that the dividend percentage can be set at other levels without departing from the scope of the invention. For any subsequent financial year, the Bank 115 will pay a dividend to the External Investors 107 based on the difference between the NAV of the U.S. dollar-backed securities 108 and the “Threshold Amount” for the U.S. dollar-backed securities 108, where the “Threshold Amount” is defined as the amount equal to the greater of (a) the NAV per U.S. dollar-backed securities 108 at the last Valuation Day in the last financial year in which a dividend was paid; or (b) the face value of the U.S. dollar-backed securities 108.

If, however, the dividend payment were to lead to either a Stop Trading Trigger event or a Decrease Allocation event, then the amount of the Investment Manager 125 would recommend either a reduction in the dividend payment or a delay in the payment of the dividend in order to avoid triggering either the Stop Trading event or the Decrease Allocation event.

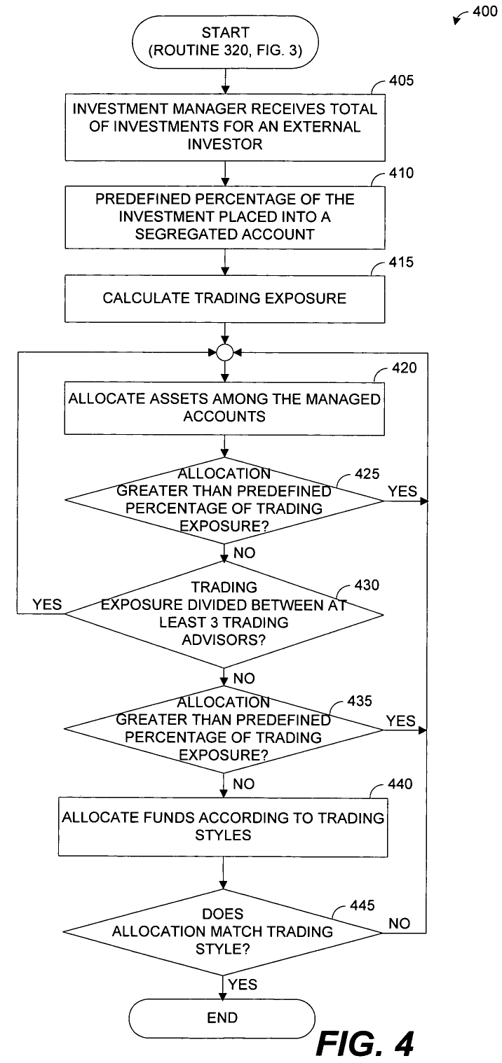

FIG. 4 is a logic flow diagram illustrating a routine 400, which is the process 320 from FIG. 3, for determining the allocation of assets among the Managed Accounts 120 by the Investment Manager 125. Routine 400 begins at 405, when the Investment Manager 125 receives the subscription for each External Investor 107. At 410 the Investment Manager 125 places a predefined percentage of the subscription into a segregated account. The predefined percentage of the subscription placed in the segregated account is set by the Bank 115 and in the present invention is set at approximately five percent (5%). The segregated account is controlled by the Investment Manager 125 and is used for several purposes. First, the segregated account may be used to insure that the Investment Fund 100 has adequate liquidity. Second, and more importantly, the segregated account may be used to hedge, or lower the exposure of the Investment Fund 100. For example, if a majority, or large number, of Trading Advisors take the same position on an investment, i.e., take a short position on the same stock, the Investment Manager 125 may use the segregated account to take an opposite position, i.e., take the short position on the same investment to reduce the exposure of the overall fund.

At 415 the Investment Manager 125 calculates the trading exposure for the Prime Broker 135, which is defined as the sum of NAV of each Managed Account 120 held by the Prime Broker 135 at the end of each business day. At 420 the Investment Manager 125 allocates the total subscriptions among the active Managed Accounts 120. Once all the subscriptions are allocated among the active Managed Accounts 120, the Investment Manager 125 determines at 425 whether the allocation to any single Trading Advisor is greater than a predefined percentage of the trading exposure. In the present invention, no more than approximately thirty-five percent (35%) of the allocations of the trading exposure may be allocated to any single Trading Advisor. If the Investment Manager 125 determines that more than 35% of the trading exposure is allocated to a single Trading Advisor, the “YES” branch is followed back to 420 where the Investment Manager 125 reallocates the assets among the Managed Accounts 120. If however, the determination is made that no single Trading Advisor has been allocated more than 35% of the trading exposure, the “NO” branch is followed to 430, where the determination is made whether the trading exposure is divided between at least three Trading Advisors. If the Trading exposure is divided among less than three separate Trading Advisors, then the “NO” branch is followed back to 430 and the Investment Manager 125 reallocates the trading exposure among the Managed Accounts 120. If on the other hand, the trading exposure is divided equally among at least three Trading Advisors, the “YES” branch is followed to 435, in which the Investment Manager 125 determines whether the overall concentration of trading styles across the Managed Account 120 match the hedging styles prescribed by the Administrator 220. Because the investment returns, volatility, and risk vary greatly among the hedging styles, the Administrator 220 will determine the overall concentration of each style to insure that the overall investment objective is achieved, which is to maximize medium-term gains in the overall NAV of the Investment Fund through closely monitored and controlled managed accounts that employ diversified hedging strategies according to Table 1.

TABLE 1
Allowed concentration Limits for hedging styles

| | Approximate |
|---|---|
| Hedging Style | Concentration Limit |
| Convertible Arbitrage | 40% |
| CTA/Futures | 20% |
| Distressed Securities | 15% |
| Equity Dedicated Short Selling | 25% |
| Equity Long/Short | 60% |
| Event Driven/Merger Arbitrage | 40% |
| Fixed Income Arbitrage | 20% |
| Fund of Funds | 0% |
| Index Arbitrage | 20% |
| Marketing Timing/Directional | 40% |
| Multi-Strategy | 40% |
| Short-Term Trading | 30% |
| Statistical Arbitrage | 40% |

If the concentration limits for the hedging strategies across the Managed Accounts 120 are not met, then “NO” branch is followed to 420 where the Investment Manager 125 reallocates the assets among the Managed Accounts 120 to insure they meet the Concentration Limits. If on the other hand, the allocations meet the required concentration limits, then the “YES” branch is followed to the “END.” Although the present invention uses the concentration limits for each trading style as described in Table 1, it should be noted that the Administrator 220 may at any time change the Concentration limits for each trading style in order to meet the investment objective of the Investment Fund 100.

71 FIG. 5 is a logic flow diagram illustrating an exemplary routine 500 from 330 (FIG. 3) for the Investment Manager 125 monitoring the daily activity of the Trading Advisors. Routine 500 begins at 505, in which the Investment Manager 125 receives the NAV for each managed account at the end of each business day from the Administrator 220. The Administrator 220 and the Investment Manager 125 are connected through a distributed network. This allows the Investment Manager 125 real-time access to the NAV and relevant trading data on a real-time basis. Additionally, by connecting the Investment Manager 125 to the Administrator 220 over a distributed network, the Investment Manger 125 has real-time access to each of the Managed Accounts 120 so that he or she can monitor the trading activity of each of the Trading Advisors in real-time. This allows the Investment Manager 125 to closely monitor the trading activities and control the risks of each Managed Account 120 to insure that the investment goals are met. Typically, the Administrator 220 and the Investment Manager 125 will be a wide area network (WAN) since the Administrator 220 will likely be based overseas while the Investment Manager 125 is based within the United States. However, other types of distributed networks, such as the Internet, or local area networks (LAN), may be used to connect the Administrator 220 with the Investment Manager 125, if the appropriate precautions are taken to safeguard the data.

The Investment Manager 125 then checks the NAV for each account against a series of predefined values to ensure that that Trading Advisors are performing as required. At 510, the Investment Manager 125 determines whether the NAV of any given Managed Account 120 declined in value more than a first predefined value at the end of the business day from the preceding business day. Typically, the first predefined value is set at ten percent (10%). Thus, if the NAV of any Managed Account 120 declines more than ten percent, the “YES” branch is followed to 515, where the Investment Manager 125 will place a restriction on the appropriate Managed Account 120 to restrict the Trading Advisor from trading at any brokerage firm other than with the Prime Broker 135. This restriction will be lifted only when the NAV of the Managed Account 120 is greater than the NAV prior to the ten percent decline for a period of ten (10) succeeding business days.

If the NAV of any Managed Account 120 has not declined in value by more than ten percent (10%), then the “NO” value is followed to 520 where the Investment Manager 125 compares the change in each NAV to the NAV for the preceding day to a second predefined value for each Managed Account 120. In the present invention, the second predefined value is set at fifteen percent (15%). If the change in NAVfor any Managed Account 120 declines in value by more than fifteen percent (15%), the “YES” branch is followed to 525 where the Investment Manager 125 restricts the appropriate Trading Advisor from using any margin or leverage. The Investment Manager 125 will remove the restrictions when the NAV of the Managed Account 120 is greater than the NAV prior to the fifteen percent decline for a period of ten succeeding business days.

Returning to 520, if the NAV of any Managed Account 120 has not declined by more than fifteen percent, the “NO” branch is followed to 530 where the change in the NAV is compared to a third predefined value. The third predefined value is set at twenty percent (20%) in the present invention. Thus, if the NAV of any Managed Account 120 declines in value by more than 20% from one business day to the next, the “YES” branch is followed to 535, in which the Investment Manager 125 removes the Trading Advisor and liquidates all positions in the relevant Managed Account and places the proceeds in a money market funds held at the Prime Broker 135.

If the NAV of any Managed Account 120 has not declined more than 20%, the “NO” branch is followed to 540, where the Investment Manger 125 determines whether the aggregate of the Managed Accounts 120 is meeting all of the Trading Constraints. For instance, the Investment Manager 125 insures that the Trading Exposure and Daily Volatility, the Loss per One Period, and the Decreased Allocation Level for the overall fund are within the limits set by the Bank 115. If any one of these constraints are not meet, the Trading Advisor is in breach of the trading constraints and the “NO” branch is followed to 545. At 545 the Investment Manager 125 must notify the Bank 115 of the breach, which typically must be given in writing. At this point, the Trading Advisor is provided a prescribed time limit to cure the breach. In the present invention, for example, the Trading Advisor must cure the breach within two (2) Calculation Dates. The prescribed time limit resembles a “probationary” period, in which the Trading Advisor is allowed to bring the fund within the limits of the Trading Constraints.

At 550, the determination is made after two Calculation Dates, whether the breach has been cured and the Managed Account 120 meets all of the Trading Constraints. If the Trading Advisor cured the breach of the Trading Constraints, then “probationary” period ends and the “YES” branch is followed to the “END” step. However, if the Trading Advisor fails to cure the breach, a Stop Trading Trigger Event is set and the “NO” branch is followed to 555. Upon the occurrence of the Stop Trading Trigger Event, the Investment Manager 125 must, within a predefined time limit of the occurrence of the Stop Trading Trigger Event, either (a) liquidate the assets of the Managed Accounts and transfer the proceeds to the Company 110 by the Breach Adjustment Date, or (b) otherwise ensure that any funds of proceeds available to the Company 110 are transferred to the Company 110 by the Breach Adjustment Date. The Investment Manager 125 may also be required to inform the Bank 115 of all actions he or she is taking in regards to liquidating the assets and the details of any positions that must be closed. Furthermore, the Investment Manager 125 may also be required to provide evidence to the Bank 115 showing the instructions to the relevant Trading Advisors to close out all positions after the occurrence of the Stop Trading Trigger Event.

Returning to 540, if the Investment Manager 125 determines that all of the Trading Constraints are met, the “NO” branch is followed to 560, where the Investment Manager 125 determines whether to close any of the Managed Accounts 120. The Investment Manager 125 may, for any reason he or she see fit, close any of the Managed Accounts 120. For instance, if the Investment Manager 125 believes that a particular Trading Advisor is not performing to a level the Investment Manger 125 feels he or she should be, even though the Trading Advisor is maintaining a positive return, the Investment Manager 125 may elect to close the relevant Managed Account 120. If the Investment Manager 125 chooses to close a particular Managed Account 120, the “YES” branch is followed to 555, where the Investment Manager 125 removes the Trading Advisor and liquidates the assets in the relevant Managed Account 120. Otherwise, the “NO” branch is followed to 565, in which the Investment Manager 125 leaves the Managed Accounts 120 intact for the current business day.

Other alternative embodiments will become apparent to those skilled in the art to which a present invention pertains without departing from its spirit and scope. Accordingly, the scope of the present invention is defined by the appended claims rather than the foregoing description.

1. A method for monitoring a plurality of managed accounts in an investment fund by an investment manager, comprising:
issuing secured notes to a plurality of external investors in exchange for assets, wherein the plurality of external investors forwards assets to an administrator;
selecting a plurality of trading advisors to manage the plurality of managed accounts, wherein each trading advisor manages at least one managed account and each of the managed accounts comprises a trading style, and wherein each managed account is held at a prime broker;
allocating the assets among at least one managed account;
dynamically monitoring the daily trading activity of each of the trading advisors managing each managed account over a distributed network;
determining a lock-in rate for issued notes based on monitored daily activity of each of the managed accounts; and
paying a dividend per annum to each external investor based on the recommended lock-in rate.

2. The method of claim 1, wherein the plurality of managed accounts are hedge funds.

3. The method of claim 2, wherein selecting the plurality of trading advisors comprises selecting each trading advisors from a plurality of potential emerging managers and comprises:
evaluating each emerging manager's past investment strategy;
evaluating each emerging manager's past performance;
evaluating each emerging manager's infrastructure of past portfolios;
evaluating each emerging manager's personal traits; and
requiring that each emerging manager invest a portion of his or her personal net worth in a hedge fund which he or she manages.

4. The method of claim 1, wherein determining a lock-in rate comprises:
calculating a net asset value NAV for the aggregate of the plurality of managed accounts; and
calculating the dividend by multiplying the NAV of the aggregate of the plurality of managed accounts by a predefined rate.

5. The method of claim 4, wherein the predefined rate is twenty percent.

6. The method of claim 3, wherein the portion of the emerging manager's net worth is ten percent.

7. The method f claim 1, wherein allocating the assets among at least one of the managed accounts comprises:
calculating a trading exposure for the investment fund; and
allocating the trading exposure among the managed accounts, wherein
no more than a first predefined percentage of the trading exposure is allocated to any one managed account;
each of a predefined number of managed accounts contain at least a second predefined percentage of the trading exposure; and
the trading style of each managed account conforms to a predetermined concentration limit.

8. The method of claim 7, wherein the first predefined percentage is about thirty five percent.

9. The method claim 7, wherein the second predefined percentage is about ten percent and the predefined number of managed accounts is ten.

10. The method of claim 7, wherein the trading styles comprise a convertible arbitrage, a CTA/Futures, a distressed securities, an equity dedicated short selling style, an equity long/short style, an event driven/merger arbitrage style, a fixed income arbitrage style, a fund of funds style, an indexed arbitrage style, a marketing timing/directional style, a multi-strategy style, a short-term trading style, and a statistical arbitrage style.

11. The method of clam 1, wherein monitoring the daily trading activity of each of the trading advisors comprises:
receiving a net asset value NAV for each managed account for each Calculation Date;
if the NAV has declined by the first predefined percentage, then restricting the trading advisor to trading at the prime broker;
if the NAV has declined by a second predefined percentage, then restricting the Trading Advisor from using any margin or leverage; and
if the NAV has declined by a third predefined percentage, then removing the Trading Advisor and liquidating the assets of the hedge fund.

12. The method of claim 11, wherein the first predefined percentage is about ten percent, the second predefined percentage is about fifteen percent, and the third predefined percentage is about twenty percent.

13. The method of claim 11, further comprising:
placing a portion of the assets of the investment fund in a segregated account; and
accessing the risk and exposure of the trading advisors investments;
using the segregated account to purchase positions contrary to the positions purchased by the trading advisors if the risk and exposure are greater than a predefined value to minimize the risk and exposure of the investment fund.

14. A system for remotely managing a plurality of trading advisor, each trading advisor operating at least one managed account, comprising capital invested by external investors and guaranteed by United States dollar or foreign-backed securities, comprising:
a bank for guaranteeing the United States backed securities;
a prime broker operable for:
holding a plurality of managed accounts, each managed account controlled by a trading advisor, wherein the prime broker comprises the assets for each of the managed accounts; and
calculating a net asset value NAV for each Managed Account; an investment advisor operable for:
issuing the guaranteed securities to external investors; and
dynamically monitoring the trading activities of the trading advisors on a daily basis to insure that the trading advisors meet a set of performance criteria; and
a distributed network, connecting the bank, prime broker, and the investment manager, such that the investment manager may dynamically monitor the trading activities of the trading advisors and restrict the trading activities if the trading advisors do not meet the set of performance criteria.

15. The system of claim 14, wherein the investment manager is further operable for:
distributing the guaranteed securities to the external investors;
selecting trading advisors to manage the individual managed accounts;
allocating the assets among the managed accounts;
managing the daily activities of the trading advisors over the distributed network; and
reviewing the net assets value NAV of each managed account and recommending a dividend amount for payment to the external investors.

16. The system of claim 14, further comprising an administrator operable for:
providing a valuation for the assets of the investment fund; and
providing the NAV of the investment fund on a monthly basis to the investment manager.

17. The system of claim 14, wherein the managed accounts are hedge funds.

18. The system of claim 15, wherein calculating a lock-in rate comprises:
calculating the NAV of the aggregate of the plurality of managed accounts; and
calculating the dividend by multiplying the NAV of the aggregate of the plurality of managed accounts by a predefined rate.

19. The system of claim 18, wherein the predefined rate is twenty percent.

20. The system of claim 15, wherein allocating the assets among the plurality of managed accounts comprises:
calculating the trading exposure for the investment fund; and
allocating the trading exposure among the plurality of managed accounts.

21. The system of claim 20, wherein allocating the trading exposure among the plurality of managed account, comprises:
allocating no more than a first predefined percentage of the trading exposure any single managed account;
allocating at least a second predefined percentage of the trading exposure to each of managed accounts; and
insuring that the trading styles of the individual managed accounts conform to predetermined concentration limits.

22. The system of claim 20, wherein the first predefined percentage is about thirty five percent.

23. The system of claim 20, wherein the second predefined percentage is about ten percent and the predefined number of managed accounts is ten.

24. The system of claim 21, wherein monitoring the daily trading activity of each of the trading advisors comprises:
receiving a net asset value NAV for each managed account;
if the NAV has declined by the first predefined percentage, then restricting the trading advisor to trading at the prime broker;
if the NAV has declined by a second predefined percentage, then restricting the trading advisor from using any margin or leverage in trading; and
if the NAV has declined by a third predefined percentage, then removing the trading advisor and liquidating the assets of the appropriate managed account.

25. The system of claim 24, wherein the first predefined percentage is about ten percent, the second predefined percentage is about fifteen percent, and the third predefined percentage is about twenty percent.

26. The system of claim 24, further comprising:
placing a portion of the invested capital of the investment fund in a segregated account; and
accessing the exposure of each managed account;
using the segregated account to purchase positions contrary to the positions purchased by held by the managed accounts if the risk and exposure are greater than a predefined value to minimize the exposure of the investment fund.

27. The system of claim 14, wherein the NAV, and information associated with the trading advisors may be accessed bye the external investors over the distributed network.
